(19) United States
(12) Patent Application Publication
(10) Pub. No.: US 2005/0157790 A1
(43) Pub. Date: Jul. 21, 2005

(54) Apparatus and mehtod of coding moving picture

(76) Inventor: Changho Lee, Sungnam City (KR)

Correspondence Address: Armstrong Kratz Quintos;Hanson & Brooks, 502 Washington Avenue, Suite 220, Towson, MD, 21204, US

(21) Appl. No.: 10/514,397

(22) PCT Filed: May 21, 2003
(86) PCT No.: PCT/KR02/00964

(51) Int. Cl. H04N 7/12

(52) U.S. Cl. 375/240.16; 375/240.03; 375/240.18; 375/240.19

(57) ABSTRACT

The present invention relates to an apparatus and method of coding moving pictures which employs a wavelet transform. In particular, the present invention performs intra frame coding by transforming video input signal, RGB signal, into moving picture compression object signal (YUV), by obtaining data through the wavelet transform and quantization of the transformed moving picture compression object signal of the certain size and, then, by outputting the data after the entropy coding. Also, the present invention performs inter frame coding.

### TECHNICAL FIELD

The present invention relates to an apparatus and method of coding moving pictures. More particularly, the present invention relates to an apparatus and method of coding moving pictures which employs a wavelet transform.

### BACKGROUND ART

Apparatuses for coding moving pictures are widely used in various fields. Video On Demand (VOD), movie service on the internet, is one of representative examples. International standards relating to an apparatus for coding moving pictures are MPEG-1, MPEG-2, MPEG-4, H. 261 and H. 263 etc. The MPEG-2 is used for high definition digital TV and DVD, and MPEG-4 is mostly used for internet broadcasting. According to the MPEG in the related art illustrated in FIG. 1, moving pictures are coded using Discrete Cosine Transform (DCT).

For example, in an intra frame coding block of an apparatus for coding moving pictures according to MPEG-2, digital video data (brightness signal and color difference signal) is divided into macro blocks of 16*16 pixels and the macro blocks are further divided into blocks of 8*8 pixels. And, a DCT coefficient is obtained by implementing DCT in every pixel block. Then, quantization coefficient is obtained by performing quantization process that produces 8*8 quantization matrix corresponding to quantization width and each frequency component for the DCT coefficient. And, the generated quantization coefficient is coded through Huffman coding and outputted.

Generally known wavelet transform has an advantage in that compressibility in intra frame coding according to MPEG based on the wavelet transform is almost twice as big as compressibility in intra frame coding according to MPEG based on DCT. However, coding system based on the wavelet transform has disadvantages in that the wavelet transform needs more memory than the DCT does and it is difficult to design and implement the wavelet transform with hardware, thereby being obstacle for commercialization.

General apparatus for coding moving pictures based on DCT performs a texture coding, when pixel blocks where motion occurs cannot be expressed into motion vectors. Because the texture coding is also based on the DCT, compressibility is lower than compressibility of the wavelet transform.

### DISCLOSURE OF INVENTION

Accordingly, an object of the present invention is to provide an apparatus and method of coding moving pictures which may improve data compressibility by performing texture coding, which is performed when pixel blocks where motion occurs cannot be expressed into motion vectors, using wavelet transform.

Another object of the present invention is to provide an apparatus and method of coding moving pictures that may have compressibility twice as big as compressibility, obtained by a system of coding moving pictures based on DCT, by using wavelet transform in intra frame coding as well as inter frame coding.

In order to achieve at least the above objects, in whole or in parts, there is provided an apparatus for coding moving pictures, including: a video signal transforming unit for transforming RGB video signal into moving picture compression object signal and outputting the transformed signal; an intra frame coding unit for wavelet transforming the moving picture compression object signal, quantizing transform coefficient obtained by the wavelet transform, entropy coding the quantized transform coefficient and outputting the entropy coded transform coefficient; and an inter frame coding unit for producing motion vectors for pixel blocks where motion occurs among pixel blocks of the moving picture compression object signal and, then, outputting the motion vectors after performing Huffman coding, or for coding pixel blocks where motion occurs in the same coding method as coding method in the intra frame coding unit.

The intra frame coding unit includes: a wavelet transforming unit for wavelet transforming Y, U and V each data of moving picture compression object signal outputted from the video signal transforming unit and outputting corresponding transform coefficients; a quantization unit for quantizing the transform coefficients outputted from the wavelet transforming unit; and an entropy coding unit for entropy coding the transform coefficients quantized by the quantization unit and outputting the entropy coded transform coefficients.

The inter frame coding unit determines whether motion occurs at each pixel block using difference between a pixel block of previous frame and the pixel block of current frame of moving picture compression object signal outputted from the video signal transforming unit. The inter frame coding unit determines whether a pixel block where motion occurs can be expressed into motion vector, outputs texture map information as the determination result and arithmetic codes the texture map information.

The inter frame coding unit includes: a motion detection unit for determining whether motion occurs at each pixel block by obtaining difference between a pixel block of previous frame and the pixel block of current frame of moving picture compression object signal and outputting the determination result as motion map information; a motion map information coding unit for storing motion map information outputted from the motion detection unit, arithmetic coding the motion map information and outputting the arithmetic coded motion map information; a motion prediction unit for determining whether pixel blocks where motion occurs can be expressed into motion vectors, by receiving values of the pixel blocks where motion occurs from the motion detection unit; a motion vector coding unit for receiving motion vectors corresponding to pixel blocks where motion occurs from the motion prediction unit, storing the received motion vectors, Huffman coding the motion vectors and outputting the Huffman coded motion vectors; and a texture coding unit for receiving pixel blocks that cannot be expressed into motion vectors from the motion prediction unit, storing the pixel blocks, quantizing transform coefficient obtained by wavelet transforming the pixel blocks, entropy coding the quantized transform coefficient and outputting the entropy coded transform coefficient. The inter frame coding unit, further, includes a texture map information coding unit for receiving from the motion prediction unit texture map information indicating whether pixel blocks where motion occurs can be expressed into motion vectors, for storing the texture map information, for arithmetic coding the texture map information and outputting the arithmetic coded texture map information.

The inter frame coding unit includes no motion block storage unit for storing values of pixel blocks, where motion does not occur, among pixel blocks of the moving picture compression object signal.

A method of coding moving pictures includes: transforming RGB video signal into moving picture compression object signal; intra frame coding that wavelet transforms the moving picture compression object signal, quantizes the wavelet transformed moving picture compression object signal, entropy codes the quantized moving picture compression object signal and outputs the entropy coded moving picture compression object signal; determining whether pixel blocks where motion occurs, among pixel blocks making up the moving picture compression object signal, can be expressed into motion vectors; and inter frame coding that produces motion vector for pixel blocks which can be expressed into motion vectors, Huffman codes the motion vectors and outputs the Huffman coded motion vectors.

Said inter frame coding is, when pixel blocks where motion occurs cannot be expressed into motion vectors, to wavelet transform the pixel blocks, to quantize transform coefficient obtained by wavelet transforming, to Golomb-Rice code the quantized transform coefficient and to output the Golomb-Rice coded transform coefficient according to said intra frame coding.

The method of coding moving pictures, further includes: determining whether motion occurs at pixel blocks by obtaining difference between pixel blocks of previous frame and the pixel blocks of current frame of the moving picture compression object signal transformed in said transforming RGB video signal into moving picture compression object signal. The method of coding moving pictures, further includes: after determining whether motion occurs at pixel blocks of the moving picture compression object signal, outputting motion map information as the determination result and arithmetic coding the texture map information.

### BRIEF DESCRIPTION OF THE DRAWINGS

FIG. 1 illustrates a configuration of apparatus for coding moving pictures by using DCT in the related art

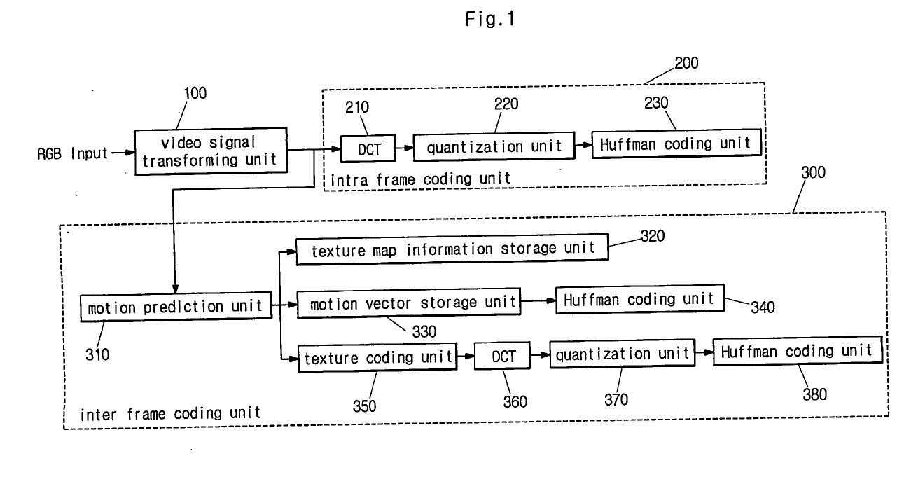

FIG. 2 illustrates a configuration of apparatus for coding moving pictures according to one preferred embodiment of the present invention.

### BEST MODE FOR CARRYING OUT THE INVENTION

Reference will now be made in detail to the preferred embodiments of the present invention, examples of which are illustrated in the accompanying drawings. Specific coding methods, such as arithmetic coding, Huffman coding, etc. are illustrated in following description and drawings, however, they are provided for helping more understanding of the present invention and it is clear that those skilled in the art can implement the present invention without the details. For explaining the present invention, detailed explanation will be omitted when it is determined that detailed explanation about well-known function and configuration of the present invention may dilute the point of the present invention.

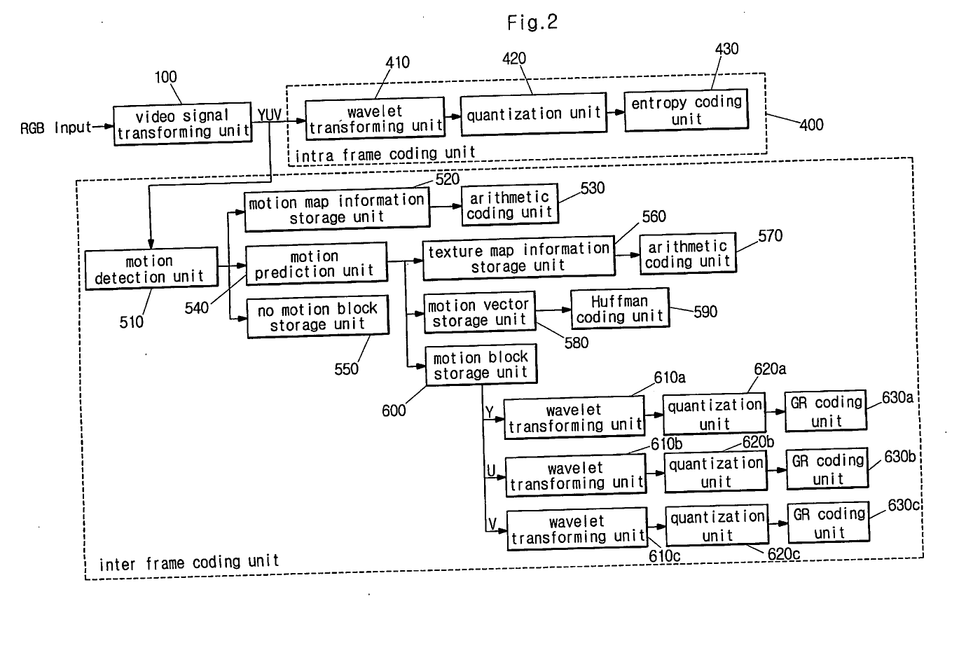

FIG. 2 illustrates a configuration of apparatus for coding moving pictures according to the preferred embodiment of the present invention. The apparatus for coding moving pictures according to the preferred embodiment of the present invention includes a video signal transforming unit 100, an intra frame coding unit 400 and an inter frame coding unit 500.

The video signal transforming unit 100 receives RGB video signals shot by camera lens and outputted from the camera lens, transforms the RGB video signals into video signals of YUV 420 format (MPEG-4 system) and outputs the video signals of the YUV 420 format. The video signal of the YUV 420 format is a moving picture compression object signal and the RGB video signals may be transformed into video signals of YUV 422 MPEG-2) and YUV 444 format.

The intra frame coding unit 400 includes a wavelet transforming unit 410, a quantization unit 420 and an entropy coding unit 430. The wavelet transforming unit 410 outputs transform coefficient obtained by wavelet transforming Y, U and V each data outputted from the video signal transforming unit 100. The quantization unit 420 increases entropy coding efficiency by quantizing the transform coefficient. The entropy coding unit 430 performs video signal compression for one frame using spatial relation in one frame by finally coding data that went through wavelet transform and quantization as preprocess for high compressibility and outputting the coded data. There are arithmetic coding, Huffman coding and Golomb-Rice coding in currently used entropy coding technology. The coding methods are already well-known, so that detailed explanation will be omitted.

The inter frame coding unit 500 includes: a motion detection unit 510; a motion prediction unit 540; a motion map information coding unit including a motion map information storage unit 520 and an arithmetic coding unit 530; a texture map information coding unit including a texture map information storage unit 560 and an arithmetic coding unit 570; a motion vector coding unit including a motion vector storage unit 580 and a Huffman coding unit 590; and a texture coding unit including a motion block storage unit 600, wavelet transforming units 610a˜610c, quantization units 620a˜620c and GR coding units 630a˜630c, corresponding to each Y, U and V.

The motion detection unit 510 determines whether motion occurs at each pixel block using difference between 8*8 pixel block of a previous frame and the pixel block of a current frame and outputs the determination result as motion map information. In other words, if motion is detected in the current frame comparing with the previous frame, motion map information is set as “1” and outputted. In contrast, if motion is not detected in the current frame, motion map information is set as “0” and outputted. The motion map information is stored in the motion map information storage unit 520, then, coded by the arithmetic coding unit 530 and outputted.

The motion prediction unit 540 receives values of pixel blocks where motion occurs from the motion detection unit 510, determines whether the pixel blocks where motion occurs can be expressed into motion vector and outputs the determination result as texture map information. Further, the motion prediction unit 540 produces motion vector and outputs the motion vector, if pixel blocks where motion occurs can be expressed into the motion vector. In contrast, if pixel blocks where motion occurs cannot be expressed into the motion vector, the motion prediction unit 540 outputs values of the motion block into the motion block storage unit 600.

The no motion block storage unit 550 stores values of pixel block where motion does not occur.

The texture map information storage unit 560 making up the texture map information coding unit stores texture map information outputted from the motion prediction unit 540. The texture map information is set as “1”, if pixel blocks where motion occurs can be expressed into motion vectors. In contrast, if the pixel blocks cannot be expressed into motion vectors, the texture map information is set as “0”. The texture map information is coded at the arithmetic coding unit 570 and outputted.

Motion vectors coded in inter frame coding mode are stored in the motion vector storage unit 580. As one of entropy coding, the Huffman coding unit 590 codes motion vectors using Huffman table and outputs the coded motion vectors. The motion vector storage unit 580 and the Huffman coding unit 590 make up the motion vector coding unit.

Values of motion blocks where motion occurs and that should be coded in intra frame coding mode are stored in the motion block storage unit 600. For motion blocks whose values are stored in the motion block storage unit 600, each Y, U and V is coded through wavelet transform unit 610a, 610b, 610c, quantization unit 620a, 620b, 620c and GR coding unit 630a, 630b, 630c and outputted.

Hereinafter, an explanation will be given as to operations of an apparatus of coding moving pictures, having the above configuration. Moving picture compression object signal of a frame unit obtained by video input device (not illustrated) such as a camera, is inputted into the wavelet transforming unit 410 of the intra frame coding unit 400 and into the motion detection unit 510 of the inter frame coding unit 500. The wavelet transforming unit 410 wavelet transforms moving picture signal of current frame inputted into the wavelet transforming unit 410 and outputs the wavelet transformed moving picture signal to the quantization unit 420. The quantization unit 420 changes the moving picture signal of the current frame into various levels of representative values through previously designated quantization process. The quantization coefficients are Golomb-Rice coded and arithmetic coded at the entropy coding unit 430 and outputted.

As described above, intra frame coding is performed by wavelet transforming, quantizing and coding moving picture signal of current frame inputted into the intra frame coding unit 400.

The motion detection unit 510 determines whether motion occurs in each pixel block or not, by using difference between 8*8 pixel block of a previous frame and the pixel block of a current frame. If it is determined that motion occurs, motion map information is set as “1” and outputted. In contrast, if it is determined that motion does not occur, the motion map information is set as “0” and outputted. The motion map information is stored in the motion map information storage unit 520 and outputted after being coded through the arithmetic coding unit 530, thereby being used for decompressing compression data at a decoding unit The motion detection unit 510 outputs values of motion blocks, where motion occurs, to the motion prediction unit 540. The motion prediction unit 540 receives from the motion detection unit 510 values of pixel blocks where motion occurs, determines whether the pixel blocks can be expressed into motion vectors and outputs the determination result as texture map information. In other words, the motion prediction unit 540 set texture map information for the pixel blocks, determined as motion blocks, as “0”, when the pixel blocks cannot be expressed into motion vectors like a case where the motion is out of searching area based on the pixel block of the previous frame. In contrast, if pixel block where motion occurs can be expressed into motion vector, texture map information is set as “1” and stored in the texture map information storage unit 560. Then, the texture map information is arithmetic coded through the arithmetic coding unit 570 and outputted, thereby being used for decompression of compressed data. The motion prediction unit 540 produces motion vector and outputs the motion vector to the motion vector storage unit 580, when pixel block where motion occurs can be expressed into motion vector. Thus, the motion vector is Huffman coded through the Huffman coding unit 590 and transferred with moving picture signals.

When motion block cannot be expressed into motion vector, coding is performed in the same method as intra frame coding mode by outputting the motion block to the motion block storage unit 600. In other words, motion blocks stored in the motion block storage unit 600 are coded through wavelet transform, quantization and Golomb-Rice coding.

Industrial Applicability

As apparent from the above description, according to the present invention, intra frame coding is performed by using wavelet transform which has superior compression performance than DCT and inter frame coding for motion blocks which cannot be expressed into motion vector is coded in the same method as the intra frame coding. Thus, the present invention has an advantage in that it has excellent compressibility in coding moving pictures whose background pictures are fixed and objects do not move a lot or moving pictures that have many motionless pictures like a monitoring system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for coding moving pictures, comprising:
a video signal ransoming unit configured to transform RGB video signal into moving picture compression object signal and to output the transformed signal;
an intra fame coding unit configured to wavelet transform the moving picture compression object signal, to quantize transform coefficient obtained by the wavelet transform, to entropy code the quantized transform coefficient and to output the entropy coded transform coefficient; and
an inter frame coding unit configured to produce motion vectors for pixel blocks where motion occurs among pixel blocks of the moving picture compression object signal and, then, to output the motion vectors after performing Huffman coding, or configured to code pixel blocks where motion occurs in the same coding method as coding method in the intra frame coding unit, wherein the inter frame coding unit comprises:
a motion detection unit configured to determine whether motion occurs at each pixel block by obtaining difference between a pixel block of previous frame and the pixel block of current frame of moving picture compression object signal and to output the determination result as motion map information;
a motion map information coding unit configured to store motion map information outputted from the motion detection unit to arithmetic code the motion map information and to output the arithmetic coded motion map information;
a motion prediction unit configured to determine whether pixel blocks where motion occurs can be expressed into motion vectors, by receiving values of the pixel blocks where motion occurs from the motion detection unit;
a motion vector coding unit configured to receive motion vectors corresponding to pixel blocks where motion occurs from the motion prediction unit, to store the received motion vectors, to Huffman code the motion vectors and to output the Huffman coded motion vectors; and
a texture coding unit configured to receive pixel blocks that cannot be expressed into motion vectors from the motion prediction unit, to store the pixel blocks, to quantize transform coefficient obtained by wavelet transforming the pixel blocks, to Golomb-Rice code the quantized transform coefficient and to output the Golomb-Rice coded transform coefficient.

2. A method of coding moving pictures, comprising:
transforming RGB video signal into moving picture compression object signal;
intra frame coding that wavelet transforms the moving picture compression object signal, quantizes the wavelet transformed moving picture compression object signal, entropy codes the quantized moving picture compression object signal and outputs the entropy coded moving picture compression object signal;
determining whether pixel blocks where motion occurs, among pixel blocks making up the moving picture compression object signal, can be expressed into motion vectors; and
inter frame coding that produces motion vector for pixel blocks which can be expressed into motion vectors, Huffman codes the motion vectors and outputs the Huffman coded motion vectors, wherein said inter frame coding is, when pixel blocks where motion occurs cannot be expressed into motion vectors, to wavelet transform the pixel blocks, to quantize transform coefficient obtained by wavelet transforming, to Golomb-Rice code the quantized transform coefficient and to output he Golomb-Rice coded transform coefficient according to said intra frame coding.
